(19) United States
(12) Patent Application Publication
(10) Pub. No.: US 2026/0118883 A1
(43) Pub. Date: Apr. 30, 2026

(54) POSITION MANAGEMENT FOR INDOOR VEHICLE NAVIGATION

(71) Applicant: Honeywell International Inc., Charlotte, NC (US)

(72) Inventors: Ranganathan Elumalai, Thiruvannamalai (IN); Balaji Bhathey, Madurai (IN); Gobinathan Baladhandapani, Madurai (IN); Karthikeyan M, Tirunelveli (IN); Marimuthu Vivek Muthuramalingam, Tirunelveli (IN); David Santhiyagu, Paramakkudi (IN); Vignesh E, Madurai (IN)

(21) Appl. No.: 18/970,239

(22) Filed: Dec. 5, 2024

(30) Foreign Application Priority Data
Oct. 24, 2024 (IN) 202411081028

(51) Int. Cl. G05D 1/646; G05D 1/249; G05D 1/622; G05D 107/60; G05D 109/20; G05D 111/30; G06T 7/70; G06V 20/52

(52) U.S. Cl. CPC G05D 1/646; G05D 1/249; G05D 1/622; G06T 7/70; G06V 20/52; G05D 2107/60; G05D 2109/20; G05D 2111/32; G06T 2207/30232; G06T 2207/30252; G06V 2201/08

(57) ABSTRACT

A method and systems for navigating a drone within a building utilizing existing a building's security camera system and network infrastructure is disclosed. During navigation, the drone is detected by the security system and/or network infrastructure to allow for real-time positioning of the drone. The system predicts movements of dynamic objects and issues corrective commands to steer the drone towards a point of destination.

### RELATED APPLICATIONS

This application claims the benefit of Indian Provisional Patent Application Number 202411081028, filed Oct. 24, 2024, which application is incorporated by reference herein.

### BACKGROUND

Autonomous airborne vehicles, or drones, typically rely on global positioning system (GPS) data when navigating from a point of origin to a destination. However, when navigating indoors, GPS data quickly becomes less useful, not only because GPS signals can be attenuated or blocked by building features, but also because the building structure may not be known to the drone. In addition, a building may be a secured space, and therefore features of the drone may be disabled prior to allowing the drone to access the building interior. New and alternative methods and systems for navigating a drone in a building are needed.

### OVERVIEW

The present disclosure generally pertains to methods of drone navigation using the information from existing building infrastructure to guide and position the drone effectively within the building.

A first illustrative and non-limiting example takes the form of a method for a drone to navigate within a building, comprising: identifying the drone's point of origin; identifying the drone's point of destination; identifying locations of structures and the drone localization devices within the building; determining a route for the drone from the point of origin to the point of destination; identifying drone localization devices to the route; a) issuing flight commands to the drone to navigate from the point of origin along the route to the point of destination; b) monitoring location of the drone using the drone localization devices as the drone travels along the route; c) issuing corrective flight commands to the drone based on its detected location; and repeating steps a)-c) until the drone reaches the point of destination.

Additionally or alternatively, the drone localization devices include at least one security camera, and the step of monitoring location of the drone further includes determining, visually using one of the at least one security camera, an orientation and position of the drone.

Additionally or alternatively, the drone localization devices include at least one security camera, and the method also comprises identifying an object or person in proximity to the route using one of the at least one security camera, and issuing flight commands to the drone to avoid the object or person in proximity to the route.

Additionally or alternatively, the drone localization devices include at least one wireless communication device, and the step of monitoring location of the drone further includes wireless triangulation using the at least one wireless communication device.

Additionally or alternatively, the route is determined based on one or more of: travel distance along the route from the drone's point of origin to the point of destination; availability of drone localization devices along the route; any known obstacles and restricted areas within the building; and an overall layout or floor plan of the building.

Additionally or alternatively, the method also includes authenticating the drone with a building management system prior to navigation within the building, wherein authenticating the drone further includes disabling at least one feature of the drone to prevent the drone engaging in unauthorized activity while in the building.

Additionally or alternatively, the route is divided into segments between waypoints, further comprising monitoring remaining portions of the route while the drone is traveling on the route, and modifying portions of the route in response to determination that a route segment is blocked or inaccessible.

Additionally or alternatively, the step of issuing flight commands is performed without using or accessing global positioning system (GPS) resources of the drone.

Another illustrative and non-limiting example takes the form of a system for navigating a drone within a building, comprising: a plurality of drone localization devices within the building; a guidance engine and a positioning engine configured to: identify a point of origin for the drone; identify a point of destination for the drone; identify drone localization devices in the building; determine a route for the drone to travel from the point of origin to the point of destination; identify relevant drone localization devices along the route; wherein the guidance engine and positioning engine are further configured to command the drone along the route from the point of origin to the point of destination by repeatedly performing the following: a) determine the drone's location using the drone localization devices; and b) issue flight commands to the drone using the determined drone location to command the drone to follow the route.

Additionally or alternatively, the drone localization devices include at least one security camera, and the positioning engine is configured to determine the drone's location by visual identification of an orientation and position of the drone using images from one of the at least one security camera.

Additionally or alternatively, the drone localization devices include at least one security camera, and the system is further configured to identify an object or person in proximity to the route using one of the at least one security camera, and to issue the flight commands to the drone to avoid the object or person in proximity to the route.

Additionally or alternatively, the drone localization devices include at least one wireless communication device, and positioning engine is configured to determine the drone's location by wireless triangulation using the at least one wireless communication device.

Additionally or alternatively, the guidance engine is configured to determine the route based on one or more of: travel distance along the route from the drone's point of origin to the point of destination; availability of drone localization devices along the route; any known obstacles and restricted areas within the building; and an overall layout or floor plan of the building.

Additionally or alternatively, the system also includes a building management system configured to authenticate the drone prior to navigation within the building, wherein the building management system is configured to disable at least one feature of the drone to prevent the drone engaging in unauthorized activity while in the building.

Additionally or alternatively, the route is divided into segments between waypoints, and the guidance engine is further configured to monitor remaining portions of the route while the drone is traveling on the route, and modify portions of the route in response to determination that a route segment is blocked or inaccessible.

Additionally or alternatively, the system is configured to issue flight commands without using or accessing global positioning system (GPS) resources of the drone.

Another illustrative and non-limiting example takes the form of a non-transitory, computer-readable medium including instructions that when executed by a processor cause the processor to guide a drone through a building, wherein the building includes a plurality of drone localization devices therein, the instructions causing the processor to: identify the drone's point of origin; identify the drone's point of destination; identify locations of structures and the drone localization devices within the building by accessing building plans; determine a route for the drone from the point of origin to the point of destination; identify drone localization devices along the route; a) issue flight commands to the drone to navigate from the point of origin along the route to the point of destination; b) monitor location of the drone using the drone localization devices as the drone travels along the route; c) issue corrective flight commands to the drone based on its detected location; and repeat steps a)-c) until the drone reaches the point of destination.

Additionally or alternatively, the drone localization devices include at least one security camera, and the instructions cause the processor to monitor location of the drone by determining, using images from the at least one security camera, an orientation and position of the drone.

Additionally or alternatively, the drone localization devices include at least one security camera, and the instructions cause the processor to identify an object or person in proximity to the route using one of the at least one security camera, and issue flight commands to the drone to avoid the object or person in proximity to the route.

Additionally or alternatively, the drone localization devices include at least one wireless communication device, and instructions cause the processor to monitor location of the drone further includes wireless triangulation using the at least one wireless communication device.

This overview is intended to introduce the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system including positioning and guidance engines;

FIG. 2 illustrates a drone in relation to security and communication devices;

FIGS. 3A-3B show an illustrative method in block form;

FIG. 4 illustrates path navigation, course correction and collision avoidance; and

FIG. 5 illustrates router-based positioning and guidance for a drone.

### DETAILED DESCRIPTION

In some illustrative examples, closed-circuit television and/or building security cameras can provide information for determining one or more optimal navigation routes. As used herein, “building security cameras” or “security cameras” encompasses any camera, whether used in a CCTV or other security system associated with a building. By relying on security cameras and/or other existing network infrastructure within a premises, a route planning system can find an optimized route and need not rely on the drone's internal navigation systems or installation of extra devices in the building. In some examples, the route of navigation is predetermined and communicated to the drone, either as a complete program or as a step-by-step or point to point set of instructions.

The drone may have reactive capabilities to respond to and avoid collision with dynamic objects. The drone's internal reactive capabilities may be augmented by use of security cameras or other building data. For example, a building's network infrastructure, including security cameras and analytics systems, may identify obstacles and/or predict movement of obstacles, and provide navigational instructions to the drone. In other examples, the drone is configured to update flight traversal information of specific routes to optimize subsequent navigation of the same flight route.

In some examples, the navigation and/or route planning system interfaces with the Building Management System (BMS) for authentication, access control, and ongoing command issuance throughout the drone's journey. In some examples, each is a separate computing module. In other examples, the BMS may incorporate the navigation and/or route planning systems. This integration with the BMS may enhance security and allow the drone's movement to be tracked as it navigates within the building. Such integration is one of several options.

A method for navigating a drone within a building is provided. An illustrative method begins by identifying the drone's point of origin and destination, as well as structures and available security cameras and/or communication devices within the building. Using this information, a route is determined. The route may be divided into multiple segments between waypoints. The relevant security cameras and network infrastructure along the route are identified. As the drone travels, these existing features in the building can be used to track the drone and adjust drone travel commands.

In an example, the navigation process involves a series of steps to direct the drone to travel from one waypoint to the next along the chosen route until the drone reaches its destination. First, flight commands are issued to guide the drone from its starting position or origin, to the first waypoint. From that point forward, flight commands are issued to guide the drone from a current position to the next waypoint.

As the drone travels, video feeds from relevant security cameras are used to track the drone's position and orientation. The movement of dynamic objects within the field of view of the engaged cameras may also be predicted. Based on the drone's detected position, orientation, and the predicted movement of dynamic objects, corrective commands are issued to steer the drone toward the next waypoint while avoiding obstacles.

The cycle of issuing commands, detecting the drone's position, predicting obstacles, and making course corrections continues until the drone successfully reaches its point of destination. Upon reaching a destination, data regarding the route taken by the drone can be stored for later use and/or learning purposes. Data may include the time required to travel the route, number of collision avoidance maneuvers undertaken by the drone, number of objects encountered by the drone, and any other suitable information that may be used for learning or revising later route choices for subsequent drone navigation and management.

Some examples take the form of a system comprising a drone, a plurality of security cameras, a building's network infrastructure, and a guidance engine paired with a positioning engine. The guidance and positioning engines receive drone's starting point and destination, and locate available network infrastructure and security cameras within the building. Using this information, the guidance engine determines a route for the drone, optionally dividing the route into multiple segments between waypoints, and identifies the relevant security cameras and network infrastructure along this route.

The drone is directed to travel the route, and the positioning engine uses building resources (security cameras and/or wireless router data, for example and without limitation) to determine drone position and orientation along the route, as well as to identify obstacles. Based on drone position and orientation, and obstacle data, the system issues commands to steer the drone along the route from the origin to the first waypoint, and then from one waypoint to the next waypoint. This process of visual detection and command issuance is repeated for each subsequent waypoint until the drone reaches its point of destination.

A building management system (BMS) is used in some examples to perform multiple roles. Route planning may use BMS information to identify floor plans and location of devices used to track drone position, including security cameras and/or wireless routers which can be used to provide wireless triangulation and identify drone position. Further, as the drone travels on the route, data from the BMS is used to determine and correct or update the drone travel path.

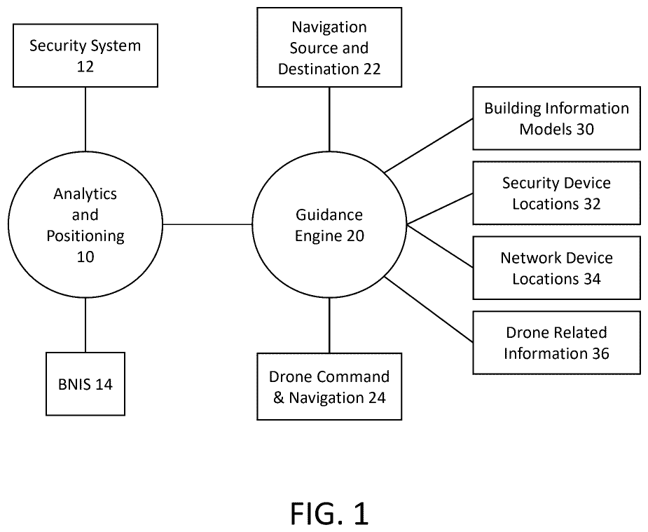

Turning to FIG. 1, a system and method for drone navigation leverages existing building network infrastructure (BNIS) 14 and analytics systems, particularly a building's security system 12, which may include the building's security cameras, as a source of real-time information in determining the drone's position. An analytics and positioning module or program 10 performs tasks related to identifying the current position and orientation of the drone based on data from the security system 12 and BNIS 14. The system shown in FIG. 1 may be part of the building management system (BMS), implemented on-site or remotely as desired, and/or may be implement on the drone itself, depending on the capabilities thereof.

In this context, a “drone” refers to any autonomous airborne vehicle capable of self-navigating and self-operating without direct human control, utilizing various sensors, positioning systems, and decision-making algorithms to perform tasks and maneuver through environments. In these examples, the drone is equipped with wireless communication capabilities to interface with the building infrastructure, particularly the BMS. These wireless communication capabilities allow the drone to receive ongoing command and navigation instructions as it navigates throughout the building.

To ensure that the drone's movements are authorized within the building, the BMS implements an authentication and monitoring process as part of its access control protocol. This process begins when drone arrives at the building with initial verification. For example, when the handshake is initiated, the drone may transmit a unique identifier, such as a serial number, registration number, or universally unique identifier (UUID), which may also be embedded in a visual marking on the drone to the BMS.

Subsequently, the BMS confirms the drone's authorization to enter by cross-referencing the drone's unique identifier against its own records of authorized drones and/or by accessing an external utility, such as a database provided by an authorized delivery service that uses drones. Once the handshake is successful, the BMS and drone are in communication with each other and ongoing communication is established, allowing for real-time updates and control.

In other examples, the drone may transmit its mission parameters to the BMS at initial verification, which can then be cross-checked against pre-defined approved criteria stored within the BMS. Mission parameters may include, but are not limited to, the specific address, suite, or office number within the building where a package needs to be delivered, the name of the receiver of any cargo, any environmental constraints (for example, whether the drone must avoid rooms set to a specific temperature by the BMS), whether there is a specific timeframe within which the mission must be completed, whether specific types of data will or should be gathered during the mission, the priority level and urgency of the mission, the specifications of the cargo (such as weight/dimensions), and whether the drone should return to its starting point after completing the task.

Likewise, the BMS may transmit mission parameters to the drone, such as, but not limited to, instructions for the drone to interact with other drones or automated systems within the building, avoidance of specific zones or rooms, dictation of the frequency and types of status updates sent to the BMS, and pre-defined emergency response protocols.

The initial verification process may also include assigning the drone a security clearance level in addition to or instead of cross-referencing the drone's identifiers or cross-checking the drone's mission parameters at entry. By assigning a security clearance level, the BMS can provide more nuanced access control. For example, the BMS can categorize clearances into multiple levels, each allowing access to different types of data or areas, as opposed to the typical binary check (“authorized” or “unauthorized”) that occurs when cross-referencing credentials.

Additionally, clearance assignments may consider a drone's operational history, performance, and past compliance with protocols, to build a trust factor over time, as opposed to the cross-referencing which typically only considers and validates credentials as they stand currently.

The initial verification process may also include disabling the drone's camera or other recording capabilities by either issuance of an electronic command or by physically applying a mask to the drone at a security desk. Doing so may prevent unauthorized activity, such as image capture, data capture, thereby accessing secured data, images, etc. in the building and/or invading privacy of building occupants. Other security measures may be dictated by the BMS or building security to protect areas from being reached or scanned by the drone. For example, handshake protocols may implement timeouts to match the building's hours of operation or prevent energy waste.

Command and navigation instructions are constructed by a drone guidance engine 20. To construct the navigation instructions, the drone guidance engine 20 utilizes information from a variety of sources, as illustrated in FIG. 1. Data may include, for example and without limitation, building information models 30, security device locations 32, network device locations 34, and/or any drone related information 36, such as, for example and without limitation, drone size, maneuverability, speed, etc.

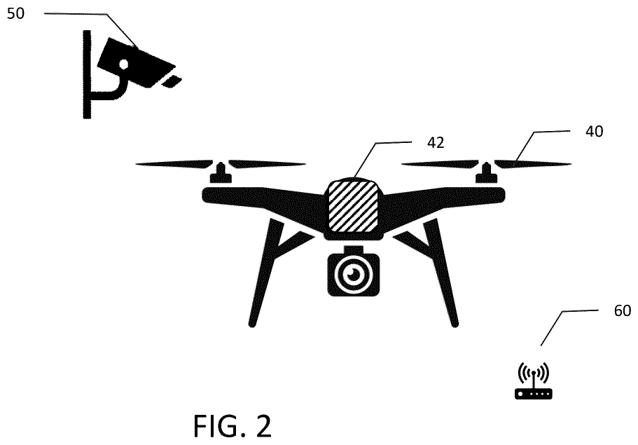

The analytics and positioning engine 10 (herein referred to as “positioning engine”), as described above, uses data obtained from the BNIS 14 and security system 12, preferably in real time, to determine the drone's position and orientation. Briefly referring to FIG. 2, in some examples, a drone 40 is outfitted with a visual marking 42 that can be identified by a building's closed-circuit television system security cameras 40. Drone location may also be determined using triangulation methods implemented by the wireless communication devices 60 in the building.

The security cameras 50 can use the visual marking and/or an observed shape of the drone to determine the drone's 40 position and orientation as it navigates through the building. The visual markers 42 may include color bands or other distinctive features or graphics easily detectable by the security cameras 50. Some examples may even provide a QR code on the drone to allow confirmation of the drone's identify, thus adding a physical layer to the security protocol for identifying the drone. As the drone navigates through the building, the security cameras 50 continuously track these markers 42 and/or the drone's observed shape features.

Turning back to FIG. 1, the location and/or orientation data from the security system 12 (including the cameras), and/or BNIS (including communications devices) provides real-time position and orientation information to the positioning engine 10. The drone's location, orientation, and heading can thus be determined. Information processed by the positioning engine 10 is then fed into the drone guidance engine 20 to generate commands 24 to navigate the drone. Additional data can be obtained by the positioning engine 10 from the drone itself, if, for example, the drone is configured to identify objects in its path or proximity to obstacles and/or objects, further augmenting the data from the security system 12 and/or BNIS 14.

The guidance engine 20 has the tasks of first defining the route, and then providing updated instructions as the drone travels by using the location, orientation and/or heading data from the positioning engine 10. In an example, the BMS provides the guidance engine 20 with building information models 30 (such as floor plans, layouts, and building schematics, and areas of controlled or restricted access), the location of the security cameras 32, the location of network devices 34 connected to the BNIS, and drone related information 36, which may include accumulated flight data.

Drone related information 36 may come from the security system and/or BNIS 14 as desired which may also be communicated by the positioning engine 10 rather than block 36, but may also include data from the drone itself. Information regarding other linked systems may also be provided, such as information derived from the BMS′ authentication and access control systems.

Route planning is performed by the guidance engine 20. Starting with drone point of origin and intended destination 22, the guidance engine 20 determines an optimal route, which may be divided into segments between a plurality of waypoints. Breaking down the route into smaller segments with defined waypoints may reduce the processing power needed at any one given time, bringing about advantages which include, but are not limited to, allowance for more frequent position checks and course corrections and overall energy consumption reduction. The optimal route is chosen using several factors, which may include:
minimization of travel distance in the route and/or minimization of time required to travel the route, determined by first obtaining motion capabilities of the drone
maximization of visual coverage by available security cameras in the route
proximity of the drone to security cameras or network devices on the route
avoidance of dead areas, in which the drone's location cannot be visually confirmed of security cameras and/or triangulated using wireless communication devices
avoidance of obstacles and restricted areas within the building
avoidance of high traffic areas, where there is significant foot traffic or where there are significant numbers of moving objects (a manufacturing line, for example), as these may present greater difficulties with identifying and avoiding moving objects and/or people
path characteristics, for example, a hallway with a relatively low ceiling (9 feet or less) may be disfavored over a hallway with a higher ceiling (greater than 9 feet), so that the drone may travel above the heads of any person walking in the hallway
   In this list, the time required to travel the route may include obtaining drone capabilities, which can include the maximum velocity of the drone including in both horizontal and vertical directions, turn radius or other turn capabilities at speed, the mass of any payload carried by the drone, or any other data that would allow the system to estimate how quickly the drone can move while traveling along the route.

In an example, route selection includes first identifying possible routes from building floor plans. Next, the possible routes are narrowed to probable routes by eliminating routes that violate route rules, wherein route rules may include one or more of disallowing routes through restricted areas, and/or disallowing routes with dead areas. Next, from the probable routes, each route may be assessed against one or more quality factors, such as length of the route, number of turns, number of obstacles, quantity of high traffic route segments, etc. The highest quality route may then be chosen. Fewer, more, or other factors may be used for determining which routes are possible and which route is optimal, as desired.

In some examples, the building resources that can be used for determining or estimating the location of the drone may be referred to as drone localization devices. Drone localization devices may include the security cameras, which are adapted or configured to perform visual determinations of where the drone is located. Precise location determinations with a camera may include observing markings or observed size of the drone, recognizing that these features do not change on the drone as the drone moves, but will appear differently as the drone approaches (features become larger) or moves away (features become smaller) from the camera.

Wireless communication devices can use triangulation, as described herein and known in the art to determine or estimate drone location as well. Other devices may be used, if present, including, for example and without limitation, any sensors present in the building, such as security or other sensors used to detect object's being present or moving in a space (for example, an electronic eye using a light emitter and detector), and or that may detect other signals, such as noises emitted by the drone (for example, a microphone used to monitor sound in an area may detect the drone approaching and/or moving away by identifying changes in volume or pitch). Any such device can be considered a drone localization device.

To the extent these drone localization devices are present in the building, they are readily distinguished from systems or devices that are outside the building, including GPS and/or radio towers, as well as from devices that are on the drone itself (a GPS chip for example) which is not part of the building infrastructure.

Once a route is determined, the route can be divided into segments between waypoints. Alternatively, a route can be implemented as a whole. With the route now known, the guidance engine 20 generates navigation commands 24 to execute navigation from the point of origin to the first waypoint, and then from one waypoint to the next. The commands 24 may include instructions for the direction, altitude, or speed of the drone.

Feedback during travel on the route can be obtained from the positioning engine 10, and use to correct or adjust the drone operations by issuing additional commands 24 or by altering commands 24 before they are sent out. For example, collision with obstacles or people may be avoided, and in the event the drone for whatever reason goes off the intended course, this feedback can be used to maintain a desired, safe route, preventing collision and/or damage to the drone or its cargo.

The methods and models herein can be implemented and/or stored on one or more controllers in the system. The controller may take many forms, including, for example, a microcontroller or microprocessor, coupled to a memory storing readable instructions for performing methods as described herein, as well as providing configuration of the controller for the various examples that follow. The controller may include one more application-specific integrated circuits (ASIC) to provide additional or specialized functionality, such as, without limitation a signal processing ASIC that can filter received signals from one or more sensors using digital filtering techniques. Logic circuitry, state machines, and discrete or integrated circuit components may be included as well. The skilled person will recognize many different hardware implementations are available for a controller. A controller as described may be included in a computer and/or server, for example. For example, each of the modules or engines shown in FIG. 1 may be executed blocks of software code stored in non-transitory memory and associated with a controller, processor or computer, including BMS computer systems as known in the art.

FIG. 1 shows the positioning engine 10 and guidance engine 20 as separate modules, and this may be the case in the physical world in some examples, such as by implementing each in separate controllers, which may be components of the BMS or may be separate from the BMS. In other examples the block diagram of FIG. 1 may be understood as a conceptual rendering, with each of the positioning engine 10 and guidance engine 20 being implemented in one controller or computer module, as desired. In other examples, each of the positioning engine 10 and guidance engine 20 are implemented in the BMS and may be software code blocks executed by the BMS computer(s). Any other suitable layout of tasks, software and hardware may be used, as desired.

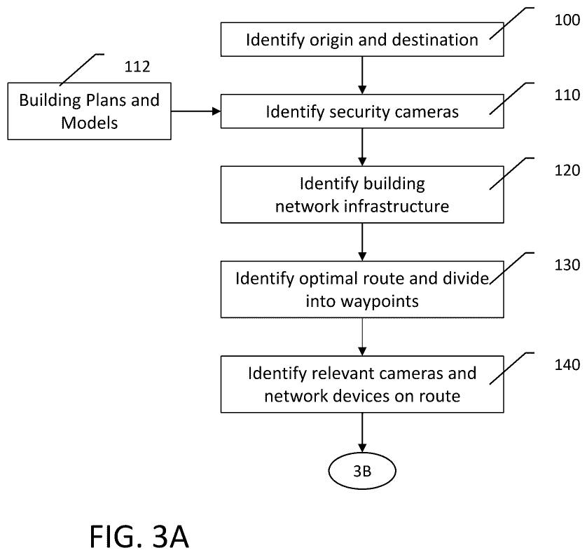

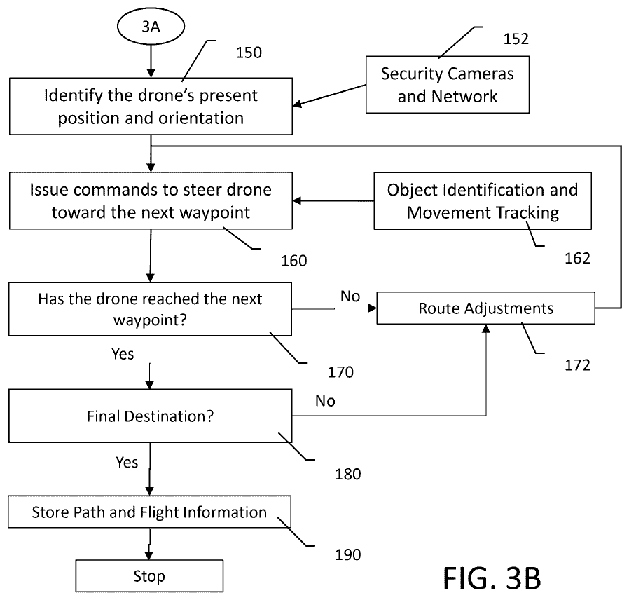

FIGS. 3A-3B illustrate a method in block form. At 100, the origin and destination for the drone are determined. This data may be a combination of the drone's identified location upon access to the building, and the intended destination form the drone's mission, where the destination may be determined directly from the drone or by referencing building data (such as a building plan) once the drone's intended destination, which may be an office, for example, is known. Building plans and models 112 may be accessed or obtained from the BMS, so that security cameras in the building are identified at 110.

Building network infrastructure is also identified at 120. Building infrastructure may include several elements, which may have several purpose. Wireless communications devices may be identified so that route planning can ensure the drone will remain in communication with the BNIS and BMS throughout the time it is in the building. That is, the drone would preferably not be navigated to any location where wireless communication is not available. In addition, the wireless communications devices may be identified for use in tracking drone location using wireless triangulation, if desired.

Next, the optimal route is identified 130, as discussed previously. Some examples will also divide the route into segments between waypoints in block 130.

The relevant cameras and network devices on the selected route from block 130 are then identified in block 140. These may include the specific security cameras that need to be engaged along the route. By selectively engaging only the cameras that are directly relevant to the drone's tracking and planned route, the visual data from the security camera's video feed that will be harvested and used can be limited, avoiding overuse of computational and network resources used to monitor and provide instructions to the drone. Route planning at this point can also then include, for each waypoint and segment, identification of the cameras and/or network devices that are expected to observe the drone. If needed, directional cameras may thus be programmed to turn to face the drone as it approaches, for example.

Additionally, selective engagement of security cameras decreases the risk of unauthorized access to video feeds of areas of the building not involved in the current navigation and limits the potential exposure of sensitive information, closed-off or secure areas, and the likenesses of building occupants. It should be noted here that in some examples, the BMS alone, the drone alone, or a combination of the drone and the BMS may perform steps involving analysis of data and instructing navigation of the drone. To the extent the drone performs such steps, limiting the drone's access to internal security data of the building may be desirable.

With the route planned and relevant resources identified, the method proceeds to FIG. 3B. At block 150, the positioning engine determines the drone's present position and orientation, using drone localization devices, such as security cameras and network resources 152. Commands are then issued at 160 to steer the drone along the route, which may include directing the drone along individual segments toward the next waypoint along the path/route.

The commands at 160 are informed as well by object identification and object movement tracking at 162. Other objects and people in the building, including other drones, but also including any other item that moves in the building, can be monitored by the security cameras, as well as by any object identification feature of the drone itself, and commands at 160 can be adjusted, either before issuance to the drone, or by the drone itself rejecting a command that may lead to a collision, if desired.

As sets of commands are issued at block 160, the system also determines from time to time whether the drone has reached the next waypoint in the path thereof, as indicated at 170. Block 170 may, for example, be checked iteratively at intervals. If the drone has not reached the next waypoint, the method next determines if any route adjustments are needed, at block 172. It may be noted that the sets of commands at block 160 may be issued, in some examples, without accessing GPS resources of the drone or without referring to GPS coordinates. Alternatively, the GPS resources of the drone and/or GPS coordinates may be referenced while other drone localization devices are also used to ensure save travel along the defined route.

Block 172 can be understood by first noting that, as the drone travels along from waypoint to waypoint, the security cameras are continuously determining and updating the drone's position and orientation, verifying that the drone is still on its correct course, in real-time. That, block 150 is performed regularly and/or continually in the method, for example, at intervals in the range of about 1 ms to 1000 ms, the drone position and orientation are determined.

When block 172 is reached, route adjustment commands are determined. In some examples, route is entirely pre-determined and fixed. However, in other examples, the system allows for dynamic rerouting when the drone is confronted with unexpected dynamic obstacles or changes in the environment occur. Thus continued and corrective commands may be generated at block 172 to adjust the intended route.

Block 172 may also include determining smaller (fine) adjustments to drone commands to keep the drone on the desired route. That is, if the drone is not on the desired course within the route, block 172 may indicate fine adjustments needed when commands are again issued at 160 in the next iteration. Fine adjustments, as that term is used, indicate adjustments within the actual travel along the route.

Fine adjustments may consider, for example, that within a building there may be multiple drones travelling, while there are also personnel and objects which may also move or be static. As with ordinary traffic (for example, cars on highways), a preferred path along the route may be pre-set, such as with the drone travelling on the right or left side of a hallway or other space, at a desired or minimum distance from the floor (preferably higher than the heads of persons walking, for example) as well as at a desired or minimum distance from the ceiling and/or wall(s).

For example, to avoid unintended collisions, the preferred path may include 10 cm (or more or less) spacing from any wall and the ceiling, and a position at least 240 cm (or more or less) from the floor. Other settings may be used, and these may be configured as part of the building plans obtained by the BMS, if desired. Different portions of the route may have different requirements in this respect.

Further, portions of the building map may be identified as preferred or not-preferred areas of the building to route drone traffic. For example, areas that are generally noisy and public may be preferred, such as cafeterias and atriums, as well as general use hallways. On the other hand, offices, meeting rooms and other places may be deemed more private and quiet. The building management system, using building plans and/or with expert (human) input, may be used to identify preferred and not-preferred spaces.

In addition, a calendar may be maintained by the building management system to allow spaces to be blocked off from drone access if desired. For example, when a company town hall is taking place in an auditorium, it may be desired to keep drones from passing through and creating distractions. If desired, certain areas may be permanently blocked off from drone access as well, such as clean rooms, restrooms, etc.

Special case adjustments may be used as well. For example, consider an elevator. In a multi-floor building, for example, a drone may need to travel on an elevator. A camera in the elevator may be used to monitor drone position while the elevator ascends or descends. For a route having an elevator portion, additional data obtained for purposes of command issuance may include using BMS communication with the elevator controls to determine when and in which direction the elevator will begin moving, and how the drone should handle such a process.

Thus both gross adjustments to the route, which may redefine waypoints and/or segments of the route after the drone has begun traversing the route, as well as small or fine adjustments within the route may be handled.

If the drone has reached a waypoint at block 170, the method then determines whether the destination has been reached, at block 180. If not, the method proceeds to block 172 to determine whether route adjustments are needed. If the destination has been reached at block 180, path and flight information are then stored, as indicated at 190. These data may be stored to maintain an audit-type database of drone travel within the building. Furthermore, the route information may be stored by the BMS for later use if, for example, another drone arrives at the same access point to the building and needs to travel to the same location as that which was previously reached.

As the drone is navigated or commanded along the route using a method as in FIG. 3B, the tasks performed by the positioning engine and the guidance engine of FIG. 1 may be divided. In an example, the positioning engine is configured to perform step 150, using data from the drone localization devices such as those noted at 152. Meanwhile, the guidance engine is configured to perform the remaining blocks shown in the figure. Other allocations of processes may be used.

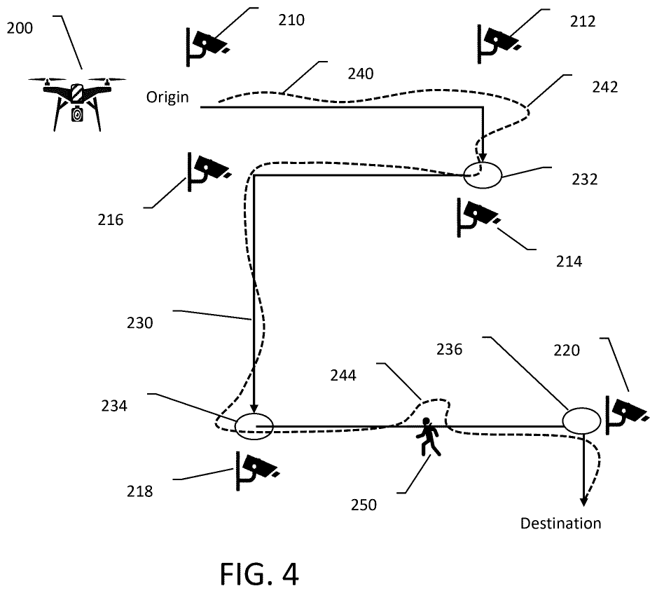

FIG. 4 illustrates how the security cameras can be used to track and guide a drone through a building. Here, the drone 200 starts at the origin, and has a destination. Security cameras are present throughout the facility, as indicated at 210, 212, 214, 216, 218 and 220. Using route determination methods described above, a route 230 is defined, with segments between waypoints 232, 234 and 236. The solid line shows the defined route, while the actual travel path of the drone is shown at 240 in a broken line.

It should be noted as well that while FIG. 4 shows the route in two dimensions, an actual route may include travel in three dimensions, as the drone may be required to move up or down while traveling in addition to motion in the horizontal plane. Ascending or descending may be performed under the drone's own power or, if present, the drone may be allowed to land or be suspended inside an elevator (such as a freight elevator or an ordinary passenger-used elevator for example) to ascend or descend.

It can be seen that the drone 200 goes off course at 242. Camera 212 and/or 214 may observe the drone going off-course, and the method shown in FIG. 3B is then used to identify that the drone is off-course, and issue corrective commands. For example, the drone 200 may be monitored to identify a distance to an ideal travel course (or range of travel course, as various aspects may be allowed to vary as the drone travels within preset bounds).

Once the drone reaches a threshold distance from the ideal travel course, corrective commands are generated. As indicated, the drone returns to the path in time to reach the waypoint 232.

Later, cameras 218 and/or 220 identify an obstacle in the path, as indicated at 250, a person is walking in the location of the path. The drone is then instructed to adjust course to go around the obstacle 250, as shown at 244, and then returns to the desired route.

Dynamic obstacles 250 can be detected in real-time via the selected security cameras. When engaged, the security cameras 218, 220 may continuously monitor for dynamic obstacles 250 as the drone navigates from waypoint 234 to waypoint 236. As can be noted, the pre-analysis performed to define the route to ensure security camera visual access to the route is useful to provide object avoidance even if the drone's internal system (camera) is turned off for privacy or security reasons.

For example, referring back to FIG. 1, the positioning engine 10 processes the data from the security system to identify such objects. The focus only needs to be, at any given instant and/or in real time, on the segment where the drone 200 is located. However, an overall review of the remaining route may be obtained periodically (though not necessarily in real time) to determine any gross adjustments to the desired route itself if, for example, a large object is moved into the path and blocks a portion of the route.

Once an obstacle 250 is identified, video feeds from the engaged cameras 218, 220, are used to predict movement of obstacle 250 within their field of view. It should be appreciated that real-time data from security camera feeds may be supplemented with data from the BMS or the drone's onboard sensors. Predictions as to where the obstacle 250 is headed may be based upon the position, density, velocity, and acceleration of the dynamic obstacle or obstacles 250; the present position, density, velocity, and acceleration of the drone; historical flight data; data from the drone's onboard sensors (e.g., the drone's own cameras or GPS), among others. Other data may be used depending on the capabilities of the guidance engine 20, the BMS design, and the building's needs, among others. Additionally, data from security camera feeds may be supplemented by data from network devices, such as Wi-Fi routers, in communication with the BMS.

The drone 200 may be steered away from the obstacle 250, or the drone 200 can also be commanded to adjust its flight speed to avoid collision, without the need to deviate from route 230. This process of detection, prediction, and route adjustment continues throughout the drone's navigation from point of origin to the destination 30. This process may also be utilized when multiple obstacles are encountered simultaneously.

If a particular waypoint becomes unreachable due to obstacles or other changes in the building's environment, the guidance engine will issue corrective commands to navigate to the next achievable waypoint, allowing the drone to maintain process towards its point of destination. The next achievable waypoint may be the next pre-defined waypoint along the route, or a newly defined waypoint generated and integrated into the existing route 230 to avoid the obstacle and maintain progress towards the point of destination. In some illustrative examples, multiple new intermediate waypoints may be generated.

In addition, portions of a predefined route may be discarded if no longer accessible, as needed. Route redefinition may be assessed continuously or may be a periodic function. In some examples, each time the drone reaches a waypoint, the remainder of the route to the destination may be assessed to ensure continued viability of the rest of the route.

Route utilization may be considered as a factor as well. If, for example, drone routes pass by personnel, such as in offices or cubicles, it may be undesirable to have those offices or cubicles (and the personnel in them) subjected to repeated interruption, noise, distraction or other intrusion. Heavily used routes may be avoided, for example.

One way to determine whether a route is likely causing distraction to on-site personnel is to determine, from the security cameras, which areas of the building are most populated at a given time. Using such information, routes may be chosen to avoid places where people are congregating.

For example, an auditorium or meeting room may be identifiable from the building plans. Security cameras or a building calendar (which may allow reservation of the auditorium or a meeting space) can be queried to determine whether the auditorium or meeting room is in use. If so, routes that would pass through the space may be avoided or deemed unusable during the identified meeting, to avoid interruption business functions.

On the other hand, a cafeteria, where noise and interruption are more accepted and expected, may not be marked as such. The cafeteria for example may be a preferred area of the route, as it may access multiple areas of the building and is not a space that is expected to be private or quiet.

One option is to allow building users to indicate on a building calendar when rooms are in use and whether drone access is to be blocked. This data may be obtained by or accessible to the building management system, for example.

Machine-learning algorithms may also be utilized to improve operations and predictions of movement. Concurrent with the use of real-time data, an algorithm may use historical data from previous navigations to predict the paths within the drone's vicinity and avoid collision. These algorithms evaluate the potential for collision and generate avoidance strategies in consideration of factors, such as, but not limited to, the drone's speed both currently and in past navigations, and the maneuverability of the drone at those speeds and at that location. As the system issues corrective commands to prevent collision, the outcomes of the ensuing maneuvers are recorded and the algorithm is updated to further improve accuracy and effectiveness for subsequent identical navigations among the route or other navigations within the building with differing routes that encounter that same specific area or type of obstacle, etc.

The choice of algorithm may take many forms, including, for example, unsupervised learning algorithms or reinforcement learning algorithms which make greater use of real-time feedback and other flight data. Supervised learning algorithms, however, can also be utilized if they are regularly retrained with data from previous navigations. Ultimately, the implemented learning algorithm is chosen by a person of ordinary skill in the art to best suit the needs of the particular environment or building infrastructure. Regardless of its form, the ultimately implemented learning algorithm will be enabled to learn from each navigation, even if the drone did not encounter obstacles 50 or changes in the environment, to refine navigational strategy.

In another example, a learning system may include a neural network. In still other examples, expert input may be obtained from an operator of the system (human input) to identify issues with any particular route. If desired, personnel in the building may be offered the opportunity to provide inputs regarding drone routes to request, for example, that certain drone routes be avoided or unused due to inconvenience, privacy, noise, or other issues.

Upon reaching the destination, the drone may complete its delivery. This may typically include delivery of a physical object to the destination. The entire process may be repeated, but in reverse, to allow the drone to then exit the building, though some adjustment can be made. Rather than returning to the point of origin, the drone may instead be instructed to depart at a closest location of exit if, for example, the building has multiple exits that the drone is allowed to use. An exit route to the chosen exit location is determined, using similar analysis as before, the drone is then guided along the exit route, again using the same principles as described above.

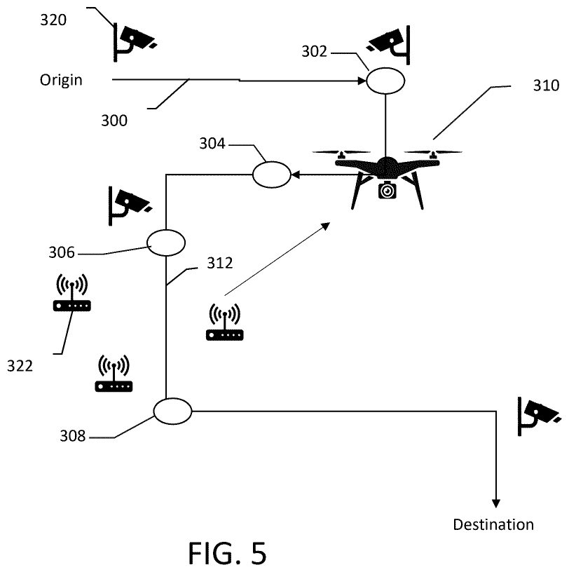

In earlier examples, the system continuously tracks the drone's position through security camera video feeds. The system may switch to alternative methods of position tracking in areas of limited or no camera coverage. That is, some examples may only select routes that can be fully monitored with video feeds, but if that is not possible, then an alternative approach may be needed. In other examples, video coverage as well as wireless device tracking may be used interchangeably. In FIG. 5, cameras 32 as well as wireless devices 322 are used to track and/or estimate the location of a drone 310 that is travelling in the building.

As illustrated in FIG. 5, existing network devices 322 within the existing BNIS may be leveraged for guiding and positioning the drone 310. This includes, but is not limited to, Wi-Fi routers and other wireless devices 322 within the building. These infrastructures are typically utilized when flight route 300 includes areas with poor or no security camera coverage. For example, segment 312 between waypoints 306, 308 may not be covered by a security camera.

As illustrated in FIG. 5, this process involves using multiple Wi-Fi routers (or other wireless devices 322 to triangulate the drone's 310 position within the building. The wireless devices 322 within the building emit signals detectable by the drone 310. The strength and quality of the signal can vary based on distance. By measuring the signal strength and time of arrival of signals from the different wireless devices, the system can calculate the drone's 310 location relative to these fixed points. This data is then processed by the positioning engine to determine the drone's location within the building.

Alternatively, the drone 310 may issue positioning related signals as part of ordinary communication or handshake with the wireless devices 322. The wireless devices may timestamp receipt of the positioning related signal from the drone 310, and can then use the timestamps to determine positioning of the drone.

To enable such triangulation, the building management system, for example, may determine from building floor plans and the like information about position of the wireless devices. This may aid the wireless devices and/or drone in estimating position or location of the drone in the building.

The processed data is subsequently fed into the guidance engine, and the guidance engine can then compare the drone's current position to the predetermined route and predetermined waypoints 302, 304, 306, 308. As a consequence of the comparison, the guidance engine may issue commands to steer the drone 310 towards the next waypoint 308 on its route 300. If an obstacle or other environmental change is present, collision avoidance or course correction measures. In some examples, when the drone is being guided without the aid of a security camera, collision avoidance may rely primarily on the drone's own sensors.

For example, the drone 322 may include various positioning related sensors useful for navigation and/or collision avoidance. These may include cameras on the drone. The drone 322 may include a light detection and ranging system (LIDAR) for determining distance to objects, people, etc. in the building. The drone 322 may also or instead include a sonic emitter and sensing system, such as an ultrasonic object detection system. Any suitable collision avoidance system may be used. The collision avoidance system of the drone may also be functional when the drone 322 is being guided using the security cameras in the building, if desired.

The transition between the security camera-based positioning and wireless device triangulation positioning is designed to be seamless through the integration of the multiple positioning methods into the system. For example, the positioning engine 10 (FIG. 1) may monitor and guide the drone while also monitoring the availability and quality of the positioning data from all linked sources in the BNIS. Due to the simultaneous nature of the monitoring, the positioning engine can therefore provide a smooth transition between the two navigation methods.

In some examples, seamless transition is further facilitated by the integration of data from the drone's internal navigation systems. Such data may be utilized during brief moments of transition between the security camera-based positioning and the wireless device triangulation positioning to ensure that there are no gaps in the data regarding the drone's position and orientation. In some examples, the drone's internal navigation systems may also be utilized to ensure route adherence in areas without sufficient security camera coverage and/or wireless device coverage.

Some examples may use the ongoing operations of the positioning engine (FIG. 1) advantageously to handle exceptions. For example, a drone that is travelling on a defined route using security camera monitoring may experience a security camera failure or interruption of security camera data (which may be treated as an exception). An illustrative response, the system may command the drone to stop moving until the security camera feed can be re-established. As an alternative or even as a subsequent response (that is, after a delay of several seconds to several minutes), the drone may proceed under an alternative form of position surveillance, including reliance on triangulation methods using wireless devices.

As the drone moves through route, there may be instances where the drone may deviate from the pre-determined route identified prior to flight due to transitions between security camera-based positioning and Wi-Fi triangulation positioning. For example, the drone may have deviated from the pre-determined route when the drone is utilizing Wi-Fi triangulation positioning which may, but not necessarily, be less precise. In another example, the drone 40 may have deviated from the pre-determined route when the drone 40 fails to use its internal navigation due to lack of signal within the building.

In the instances where the drone 40 has deviated from the initial route determination, the BMS identifies the position and orientation of the drone 40 and feeds that information to the guidance engine 50, wherein the guidance engine 50 then issues corrective commands 150 to steer the drone either back to its pre-determined route 200 or create a new route to reach the next waypoint 25 or the final point of destination 30. In other examples, corrective commands 150 may modify the location of the next waypoint 25 or create a new intermediate waypoint 25d between the previously determined waypoints 25a, 25b, as shown in FIG. 6.

Once the drone has reached the point of destination, the BMS will confirm that the drone has successfully physically reached its destination. This may include, for example, querying the drone, or a person or device (including a security camera for example) located at the destination. In other examples, wherein the drone had previously presented the BMS with mission parameters at the initial handshake, confirmation that the task was completed in accordance with the mission parameters also occurs. The BMS may also store this data for later audits to confirm that the drone had valid, initial authentication and fulfilled its mission in accordance with the mission parameters presented during the initial handshake.

After the drone has reached the point of destination, machine learning algorithms may be utilized to optimize the route further for subsequent navigation. Data from the drone's flight is collected, which is used to update the accumulated flight data already within the BMS.

If the route included course correction or collision avoidance maneuvers, the amount and character of any course corrections, any obstacles that were encountered, the efficiency of the route, and any unexpected environmental changes, such as deviations from the initially communicated building's floor plans or models, are also collected as flight traversal information. The accumulated flight data, including flight traversal information, is then integrated into the algorithm, processed, and analyzed to extract relevant features and patterns for each navigation event. Referring to FIG. 1, such data may be part of the drone related information 36 and/or may be part of the building information models that the BMS stores.

For example, the system may identify frequently used routes, consistently congested areas, areas where the drone frequently encounters dynamic obstacles, or the effectiveness of different waypoint selections or corrective commands. As the machine learning algorithm is trained on the processed data, potential routes and/or route segments within the building can be improved. As more data is collected from each subsequent drone navigation, the machine learning models are updated and refined, leading to increasingly accurate and efficient route predictions. For example, the system may update the BMS on the building's layout and floor plans and the location and coverage of security cameras and other network devices.

As another example, the BMS may be updated of the drone's 40 serial number, other numerical identifier, or visual marking 44 as authorized so that re-authentication is not necessary to gain entry to paths previously taken. Other authentication information, such as the level of security clearance, may also be updated to better tailor a set of mission parameters.

In examples the building management system is aware of the drone's presence in the building. The BMS may, in examples, continuously track the drone's passage through the building to ensure that the drone reaches its intended destination. The BMS may track how long the drone is traveling along the route, or how fast the drone is traveling and may compare to previous passages by drones along the same or similar routes. If the drone is travelling slower or faster than in previous iterations, the BMS may trigger additional monitoring, such as by an operator, to determine why.

If a drone fails to reach a planned destination, the BMS, having been tracking the drone's position, can be queried as to where the drone is. If the drone does not reach its planned destination in an expected time frame (which may be calculated using prior drone travels along the planned route, for example), the BMS may issue an alert once it becomes apparent the drone is not where it is expected to be or has not gotten to the target location in the expected time.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A method for a drone to navigate within a building, comprising:
identifying the drone's point of origin;
identifying the drone's point of destination;
identifying locations of structures and the drone localization devices within the building;
determining a route for the drone from the point of origin to the point of destination;
identifying drone localization devices to the route;
a) issuing flight commands to the drone to navigate from the point of origin along the route to the point of destination;
b) monitoring location of the drone using the drone localization devices as the drone travels along the route;
c) issuing corrective flight commands to the drone based on its detected location; and
repeating steps a)-c) until the drone reaches the point of destination.

2. The method of claim 1, wherein the drone localization devices include at least one security camera, and the step of monitoring location of the drone further includes determining, visually using one of the at least one security camera, an orientation and position of the drone.

3. The method of claim 1, wherein the drone localization devices include at least one security camera, and the method also comprises identifying an object or person in proximity to the route using one of the at least one security camera, and issuing flight commands to the drone to avoid the object or person in proximity to the route.

4. The method of claim 1, wherein the drone localization devices include at least one wireless communication device, and the step of monitoring location of the drone further includes wireless triangulation using the at least one wireless communication device.

5. The method of claim 1, wherein the route is determined based on one or more of:
travel distance along the route from the drone's point of origin to the point of destination;
availability of drone localization devices along the route;
any known obstacles and restricted areas within the building; and
an overall layout or floor plan of the building.

6. The method of claim 1, further comprising authenticating the drone with a building management system prior to navigation within the building, wherein authenticating the drone further includes disabling at least one feature of the drone to prevent the drone engaging in unauthorized activity while in the building.

7. The method of claim 1, wherein the route is divided into segments between waypoints, further comprising monitoring remaining portions of the route while the drone is traveling on the route, and modifying portions of the route in response to determination that a route segment is blocked or inaccessible.

8. The method of claim 1, wherein the step of issuing flight commands is performed without using or accessing global positioning system (GPS) resources of the drone.

9. A system for navigating a drone within a building, comprising:
a plurality of drone localization devices within the building;
a guidance engine and a positioning engine configured to:
identify a point of origin for the drone;
identify a point of destination for the drone;
identify drone localization devices in the building;
determine a route for the drone to travel from the point of origin to the point of destination;
identify relevant drone localization devices along the route;
wherein the guidance engine and positioning engine are further configured to command the drone along the route from the point of origin to the point of destination by repeatedly performing the following:
a) determine the drone's location using the drone localization devices; and
b) issue flight commands to the drone using the determined drone location to command the drone to follow the route.

10. The system of claim 9, wherein the drone localization devices include at least one security camera, and the positioning engine is configured to determine the drone's location by visual identification of an orientation and position of the drone using images from one of the at least one security camera.

11. The system of claim 9, wherein the drone localization devices include at least one security camera, and the system is further configured to identify an object or person in proximity to the route using one of the at least one security camera, and to issue the flight commands to the drone to avoid the object or person in proximity to the route.

12. The system of claim 9, wherein the drone localization devices include at least one wireless communication device, and positioning engine is configured to determine the drone's location by wireless triangulation using the at least one wireless communication device.

13. The system of claim 9, wherein the guidance engine is configured to determine the route based on one or more of:
travel distance along the route from the drone's point of origin to the point of destination;
availability of drone localization devices along the route;
any known obstacles and restricted areas within the building; and
an overall layout or floor plan of the building.

14. The system of claim 9, further comprising a building management system configured to authenticate the drone prior to navigation within the building, wherein the building management system is configured to disable at least one feature of the drone to prevent the drone engaging in unauthorized activity while in the building.

15. The system of claim 9, wherein the route is divided into segments between waypoints, and the guidance engine is further configured to monitor remaining portions of the route while the drone is traveling on the route, and modify portions of the route in response to determination that a route segment is blocked or inaccessible.

16. The system of claim 9, wherein the system is configured to issue flight commands without using or accessing global positioning system (GPS) resources of the drone.

17. A non-transitory, computer-readable medium including instructions that when executed by a processor cause the processor to guide a drone through a building, wherein the building includes a plurality of drone localization devices therein, the instructions causing the processor to:
identify the drone's point of origin;
identify the drone's point of destination;
identify locations of structures and the drone localization devices within the building by accessing building plans;
determine a route for the drone from the point of origin to the point of destination;
identify drone localization devices along the route;
a) issue flight commands to the drone to navigate from the point of origin along the route to the point of destination;
b) monitor location of the drone using the drone localization devices as the drone travels along the route;
c) issue corrective flight commands to the drone based on its detected location; and
repeat steps a)-c) until the drone reaches the point of destination.

18. The non-transitory, computer-readable medium of claim 17, wherein the drone localization devices include at least one security camera, and the instructions cause the processor to monitor location of the drone by determining, using images from the at least one security camera, an orientation and position of the drone.

19. The non-transitory, computer-readable medium of claim 17, wherein the drone localization devices include at least one security camera, and the instructions cause the processor to identify an object or person in proximity to the route using one of the at least one security camera, and issue flight commands to the drone to avoid the object or person in proximity to the route.

20. The non-transitory, computer-readable medium of claim 17, wherein the drone localization devices include at least one wireless communication device, and instructions cause the processor to monitor location of the drone further includes wireless triangulation using the at least one wireless communication device.
